(19) United States
(12) Patent Application Publication
(10) Pub. No.: US 2009/0117409 A1
(43) Pub. Date: May 7, 2009

(54) PERPENDICULAR MAGNETIC RECORDING MEDIUM AND METHOD OF MANUFACTURING THE SAME

(75) Inventors: Hoo-san LEE, Osan-si (KR); Hoon-sang Oh, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/117,766

(22) Filed: May 9, 2008

(30) Foreign Application Priority Data
Nov. 2, 2007 (KR) 10-2007-0111752

(51) Int. Cl. G11B 5/62; G11B 5/84

(52) U.S. Cl. 428/836.1; 428/836; 427/131

(57) ABSTRACT

A perpendicular magnetic recording medium and a method of manufacturing the same are provided. The perpendicular magnetic recording medium includes a substrate, and a recording layer comprising a plurality of independent first magnetic body regions and a plurality of second magnetic body regions formed on the substrate, the second magnetic body regions separating the first magnetic body regions from each other, and being formed by implanting dopant into a region in which the first magnetic body regions are to be separated. Each of the first magnetic body regions has an L1₀ structure and the dopant has an ionic or molecular shape.

### CROSS-REFERENCE TO RELATED PATENT APPLICATIONS

This application claims priority from Korean Patent Application No. 10-2007-0111752, filed on Nov. 2, 2007, in the Korean Intellectual Property Office, the disclosure of which is incorporated herein in its entirety by reference.

### BACKGROUND OF THE INVENTION

1. Field of the Invention

Apparatuses and methods consistent with the present invention relate to a perpendicular magnetic recording medium and a method of manufacturing the same and, more particularly, to a perpendicular magnetic recording medium having a recording layer with a smaller grain size and a large magnetic anisotropic energy and, a method of manufacturing the same.

2. Description of the Related Art

Due to a recent, rapid increase in the amount of information, information-memorizing apparatuses capable of recording/reproducing data with a higher density are required. In particular, since magnetic recording apparatuses using a recording medium have the characteristics of large capacity and high accessibility, the magnetic recording apparatuses are highlighted as information memorizing apparatuses used in various digital devices including computers.

Magnetic recording that is to be performed by the magnetic recording apparatus may be largely classified into a longitudinal magnetic recording method and a perpendicular magnetic recording method. In the longitudinal magnetic recording method, information is recorded by using the characteristic that the magnetization direction of a magnetic layer is aligned on the surface of the magnetic layer to be parallel to the surface of the magnetic layer, and in the perpendicular magnetic recording method, information is recorded by using the characteristic that the magnetization direction of the magnetic layer is aligned on the surface of the magnetic layer to be perpendicular to the surface of the magnetic layer. In view of the recording density, the perpendicular magnetic recording method is more advantageous than the longitudinal magnetic recording method.

The structure of a perpendicular magnetic recording medium is a double structure comprising a soft magnetic underlayer making a magnetic path of a recording magnetic field, and a recording layer that is magnetized by the recording magnetic field in a vertical direction (up/down).

In order to perform high density recording by using the perpendicular magnetic recording method, the perpendicular magnetic recording medium having the characteristics of a high coercive force and a perpendicular magnetic anisotropic energy of the recording layer for securing the stability of recorded data, and a small grain size and a small magnetic domain size caused by small exchange coupling between grains is required.

When the grain is small with a size of several nm, a problem occurs in terms of thermal stability. Thus, a technology for forming a material of which grain size is small and magnetic anisotropic energy is large is needed.

### SUMMARY OF THE INVENTION

The present invention provides a perpendicular magnetic recording medium in which grains of a recording layer are thermally stably and finely formed, and of which magnetic anisotropic energy is large, and a method of manufacturing the same.

According to an aspect of the present invention, a perpendicular magnetic recording medium comprises a substrate; and a recording layer comprising a plurality of independent first magnetic body regions and a plurality of second magnetic body regions formed on the substrate, the second magnetic body regions separating the first magnetic body regions from each other, and being formed by implanting a dopant into a region in which the first magnetic body regions are to be separated.

According to another aspect of the present invention, a method of manufacturing a perpendicular magnetic recording medium, the method comprises forming a recording layer, having the shape of a continuous layer, on a substrate; forming a mask on the recording layer; and forming a plurality of independent first magnetic body regions and a plurality of second magnetic body regions, separating the first magnetic body regions from each other, within the recording layer, by implanting a dopant into the recording layer through the mask.

### BRIEF DESCRIPTION OF THE DRAWINGS

The above and other features and aspects of the present invention will become more apparent by describing in detail exemplary embodiments thereof with reference to the attached drawings, in which:

FIG. 1 is a schematic cross-sectional view of a perpendicular magnetic recording medium according to an exemplary embodiment of the present invention;

FIG. 2 illustrates the structure of a recording layer of the perpendicular magnetic recording medium of FIG. 1; and

FIGS. 3A through 3D are cross-sectional views illustrating a method of manufacturing a perpendicular magnetic recording medium according to another exemplary embodiment of the present invention.

### DETAILED DESCRIPTION OF EXEMPLARY EMBODIMENTS OF THE INVENTION

The present invention will now be described more fully with reference to the accompanying drawings, in which exemplary embodiments of the invention are shown. The present invention may, however, be embodied in many different forms and should not be construed as being limited to the exemplary embodiments set forth herein; rather, these embodiments are provided so that this disclosure will be thorough and complete, and will fully convey the concept of the invention to one skilled in the art.

Like reference numerals in the drawings denote like elements, and in the drawings, the thicknesses of layers and regions are exaggerated for clarity.

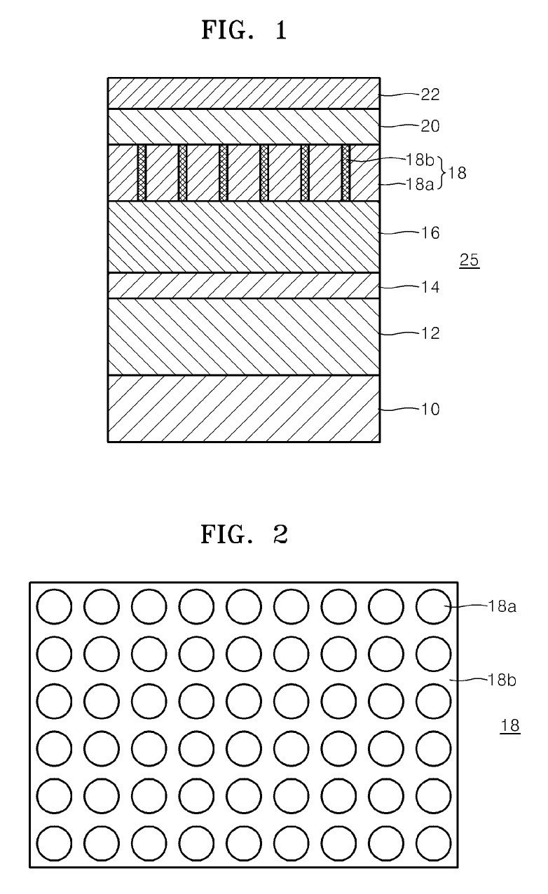

FIG. 1 is a schematic cross-sectional view of a perpendicular magnetic recording medium according to an exemplary embodiment of the present invention.

Referring to FIG. 1, the perpendicular magnetic recording medium 25 comprises a soft magnetic underlayer 12, a buffer layer 14, an intermediate layer 16, a recording layer 18, a protection layer 20, and a lubrication layer 22, which are sequentially stacked on a substrate 10.

The substrate 10 may be usually formed of glass or an AlMg alloy in a disc shape.

The soft magnetic underlayer 12 is used to form a magnetic path of a perpendicular magnetic field that is generated from a recording head during a magnetic recording so that information can be recorded to the recording layer 18. The soft magnetic underlayer 12 may be formed of Fe, an Fe−Si alloy, an Ni−Fe alloy or a Co-based alloy that may be CoZrNb or CoFeZrNb, for example.

The buffer layer 14 is used to suppress a magnetic interaction between the soft magnetic underlayer 12 and the recording layer 18, and may be formed of Ti or Ta, for example.

The intermediate layer 16 is used to improve crystalline orientation and magnetic characteristics of the recording layer 18, and may also be formed as a multiple layer. A material used in forming the intermediate layer 16 is determined depending on a material for forming the recording layer 18 and the structure of the recording layer 18. For example, the intermediate layer 16 may be formed of a Cr alloy or MgO.

The recording layer 18 may be formed of CoPt alloy or FePt alloy having a granular shape such that the recording layer 18 comprises first and second magnetic body regions 18a and 18b. The recording layer 18 may be formed as a multiple layer. A detailed description of the recording layer 18 will be described later.

The protection layer 20 is used to protect the recording layer 18 from the outside, and may be formed of diamond like carbon (DLC). The lubrication layer 22 is formed on the protection layer 20 such that the lubricant layer 22 is formed of a Tetraol lubricant to prevent wear of a magnetic head and the protection layer 20 due to collision and sliding with a magnetic head.

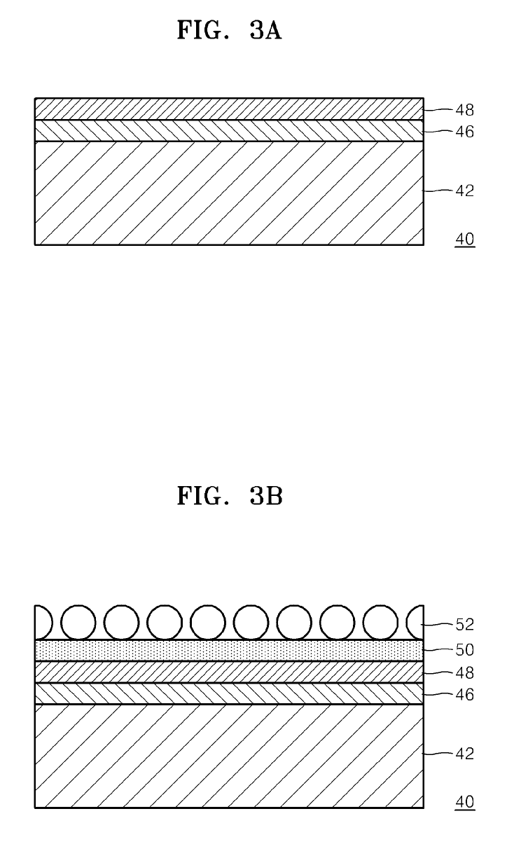

FIG. 2 illustrates the structure of the recording layer 18 of the perpendicular magnetic recording medium 25 of FIG. 1.

Referring to FIG. 2, the recording layer 18 comprises the independent first magnetic body regions 18a in a granular shape and the second magnetic body regions 18b separating the first magnetic body regions 18a. In order for the perpendicular magnetic recording medium 25 to have a high recording density, the grain size of the recording layer 18 should be small so that the grain size is less than 10 nm, and thus, a separation state between grains should be maintained. However, when the grain size is small, the recording layer 18 is thermally unstable. Thus, in order to solve such problem, a material having a large magnetic anisotropic energy is needed, and the material may be CoPt or FePt having an L10 structure or CoPt having an hcp structure. The recording layer 18 may be formed of CoPt or FePt having an L10 structure.

Each of the first magnetic body regions 18a may be formed of CoPt or FePt having an L10 structure and a diameter of each of the first magnetic body regions 18a may be 4-10 nm. The magnetic anisotropic energy Ku of each of the first magnetic body regions 18a is 105 erg/cc to 108 erg/cc.

Each of the second magnetic body regions 18b has different characteristics from those of the first magnetic body regions 18a so as to separate the first magnetic body regions 18a from each other. Each of the second magnetic body regions 18b is formed by implanting dopant into a region in which the first magnetic body regions 18a on the recording layer 18 formed of CoPt or FePt having an L10 structure are to be separated. The dopant may have the shape of an ion such as He ion or Ga ion or a molecular shape such as BnHm (where n and m are integers, n>10, 0≦m≦22) having a predetermined volume and containing boron (B). For example, the molecular shape may be B18H22. The magnetic anisotropic energy of the second magnetic body regions 18b may be reduced or the second magnetic body regions 18b may lose magnetism due to dopant implantation. This phenomenon may be understood as a phenomenon that occurs by the breakage of the crystallinity of a magnetic body due to a dopant. The magnetic anisotropic energy Ku of each of the second magnetic body regions 18b may be less than 104 erg/cc. The crystalline structure of each of the second magnetic body regions 18b may be an amorphous structure.

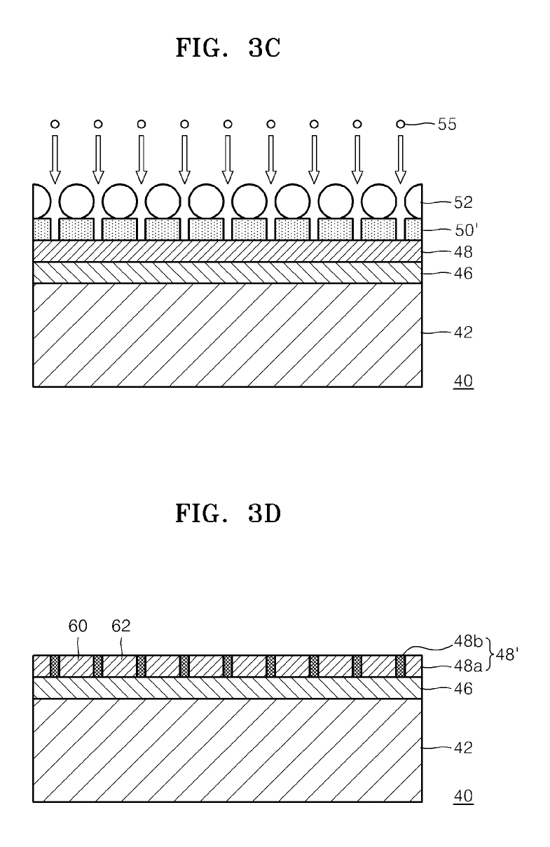

FIGS. 3A through 3D are cross-sectional views illustrating a method of manufacturing a perpendicular magnetic recording medium according to an exemplary embodiment of the present invention.

Referring to FIG. 3A, a soft magnetic underlayer 42, an intermediate layer 46 and a recording layer 48 are sequentially formed on a substrate 40. The recording layer 48 may be formed by crystallizing an FePt layer in an L10 structure having the shape of a continuous layer at 350° C. using sputtering. For example, the substrate 40 may be heated before deposition and the FePt layer may be deposited before the heated substrate 40 is cooled down, thereby forming the FePt layer in the L10 structure. Alternatively, the recording layer 48 may be formed by forming, thermally treating and crystallizing the FePt layer in the L10 structure. The intermediate layer 46 may be formed of an MgO layer so that the recording layer 46 can be well oriented in the L10 structure. The soft magnetic underlayer 42 may be formed of an FeSi layer.

Referring to FIG. 3B, after an etching protection layer 50 is formed on the recording layer 48 that is crystallized in the shape of a continuous layer, the etching protection layer 50 is patterned. The etching protection layer 50 may be formed of a silicon oxide layer or a polycrystalline silicon layer, and may be patterned using a nanoparticle mask method, for example. In the nanoparticle mask method, as illustrated in FIG. 3B, the etching protection layer 50 is patterned using nanoparticles 52 as a mask. The nanoparticles 52 may be formed of a metallic material or a semiconductor material and the diameter of the nanoparticles 52 is approximately 5 nm. When the nanoparticles 52 are coated on the etching protection layer 50 to a small diameter, predetermined patterns are formed the etching protection layer 50 by the gap between the nanoparticles 52 that are used as a mask for pattering the etching protection layer 50. The etching protection layer 50 is patterned based on the masking of the nanoparticles 52. Patterning of the etching protection layer 50 may also be performed using high-density ion etching methods such as inductively coupled plasma-reactive ion etching (ICP-RIE) or reactive ion etching (RIE). In this case, the patterns formed by the gap between the nanoparticles 52 do not need to be regular patterns and may be formed in units of the size of the nanoparticles 52.

Next, referring to FIGS. 3C and 3D, Ga ions 55 with a dose of 1012-1013/cm2 are implanted into the recording layer 48 by passing through a patterned etching protection layer 50′, and when the implantation of the Ga ions 55 is completed, the patterned etching protection layer 50′ and the nanoparticles 52 are removed. The Ga ions 55 are an example of a dopant which causes a change in the magnetism of the recording layer 48, however the present invention is not limited thereto, and thus, the dopant may be He ions or BnHm compounds (where n and m are integers, n>10, 0≦m≦22). As illustrated in FIG. 3D, the first magnetic body regions 48a are formed in an L10 structure having a size of approximately 5 nm such that the Ga ions 55 are not implanted therein, and the second magnetic body regions 48b are formed with the implantation of the Ga ions 55, such that the first magnetic body regions 48a and the second magnetic body regions 48b form a recording layer 48′. The magnetic anisotropic energy of the second magnetic body regions 48b may be reduced or the second magnetic body regions 48b may lose magnetism due to the dopant implantation. The crystalline structure of the second magnetic body regions 48b may be changed into an amorphous structure. As such, the first magnetic body regions 48a are separated from one another by the second magnetic body regions 48b and the recording layer 48′ is formed in a granular shape. After the patterned etching protection layer 50′ and the nanoparticles 52 are removed, a process of forming a protection layer and lubrication layers (not shown) on the recording layer 48′ may be performed.

In the present exemplary embodiment, in order to implant ions into the recording layer 48, first, after the etching protection layer 50 is patterned using the nanoparticle mask method as described above, ions are implanted into the recording layer 48 using the patterned etching protection layer 50′. However, the present invention is not limited to this. For example, a process of forming and patterning the etching protection layer 50 may be omitted and the nanoparticles 52 may be coated on the recording layer 48, and then, the dopant may be directly implanted into the recording layer 48 by using the nanoparticles 52 that are coated on the recording layer 48 as a mask.

While the present invention has been particularly shown and described with reference to exemplary embodiments thereof, it will be understood by one of ordinary skill in the art that various changes in form and details may be made therein without departing from the spirit and scope of the present invention as defined by the following claims.

What is claimed is:

1. A perpendicular magnetic recording medium comprising:
a substrate; and
a recording layer comprising a plurality of independent first magnetic body regions and a plurality of second magnetic body regions formed on the substrate, the second magnetic body regions separating the first magnetic body regions from each other, and being formed by implanting a dopant into a region in which the first magnetic body regions are to be separated.

2. The medium of claim 1, wherein each of the first magnetic body regions has an L1₀ structure.

3. The medium of claim 1, wherein the recording layer is formed of CoPt alloy or FePt alloy.

4. The medium of claim 1, wherein the size of each of the first magnetic body regions is 4-10 nm.

5. The medium of claim 1, wherein a magnetic anisotropic energy of each of the first magnetic body regions is 10⁵ erg/cc to 10⁸ erg/cc.

6. The medium of claim 1, wherein the dopant has an ionic or molecular shape.

7. The medium of claim 1, wherein a magnetic anisotropic energy of each of the second magnetic body regions is less than 10⁴ erg/cc.

8. The medium of claim 1, wherein each of the second magnetic body regions has an amorphous structure.

9. The medium of claim 1, wherein at least one of a soft magnetic underlayer, a buffer layer and an intermediate layer is formed between the substrate and the recording layer.

10. A method of manufacturing a perpendicular magnetic recording medium, the method comprising:
forming a recording layer, having the shape of a continuous layer, on a substrate;
forming a mask on the recording layer; and
forming a plurality of independent first magnetic body regions and a plurality of second magnetic body regions, separating the first magnetic body regions from each other, within the recording layer, by implanting a dopant into the recording layer through the mask.

11. The method of claim 10, wherein the recording layer having a continuous layer is formed in an L1⁰ structure.

12. The method of claim 10, wherein the recording layer is formed of CoPt alloy or FePt alloy.

13. The method of claim 10, wherein the forming of the mask is performed using a nanoparticle mask method.

14. The method of claim 13, wherein the pattern size of the mask is 4-10 nm.

15. The method of claim 10, wherein the dopant has an ionic or molecular shape.

16. The method of claim 15, wherein the ion is an He ion or Ga ion and the molecule is BnHm (where n and m are integers, n>10, 0≦m≦22) having a predetermined volume.

17. The method of claim 10, wherein a magnetic anisotropic energy of each of the second magnetic body regions is less than 10⁴ erg/cc.
